(19) United States
(12) Patent Application Publication
(10) Pub. No.: US 2008/0063180 A1
(43) Pub. Date: Mar. 13, 2008

(54) ESTIMATING WAIT TIME FOR CALLING

(75) Inventors: Eric L. Barsness, Pine Island, MN (US); John M. Santosuosso, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/466,578

(22) Filed: Aug. 23, 2006

(51) Int. Cl. H04M 3/00

(52) U.S. Cl. 379/265.14

(57) ABSTRACT

A method, computer program product and system for estimating a wait time for a termination of a conversation includes referencing one of historical logs and other information for determining and providing the estimation to caller. Typically, a call may be initiated when the estimated wait time is reached as the conversation will have or nearly have terminated.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to estimation of a waiting time for reaching a party when placing calls with a mobile station.

2. Description of the Related Art

Often, when a user places a call using a mobile station (e.g., a cellular telephone, or a cell phone) a busy signal is received. When this occurs, the user terminates the call, and calls again later at some time when the receiving party is likely to have completed their conversation. However, this is typically bothersome for users of mobile stations, as the user is likely calling for a matter of some importance while attempting to maintain a busy schedule.

It is known in the prior art to provide users of certain communication systems with wait times. Reference may be had to Cuhls et al. (U.S. Patent Publication No. 2005/0198107 A1). Cuhls et al. discloses a mechanism for providing patrons waiting in a service provider's queue with information as to their status in the queue. While a patron is in the queue, at time intervals specified which may be user selectable, an estimate of the time remaining is calculated based on the patron's current position in the queue. Unfortunately, the teachings therein apply to the service provider's queue and do not attempt to address the issues associated with calls placed from a mobile station to another telephone.

What are needed are techniques users of mobile stations to obtain an estimate of a wait time before a call recipient will be available.

### SUMMARY OF THE INVENTION

Disclosed herein is a method for providing a caller with an estimated wait time for calling a party engaged in a conversation with at least another party following a termination of the conversation, the method including: identifying at least one party to the conversation; using the identity of the at least one party, determining the estimated wait time for the caller; and providing the estimated wait time to the caller.

A system for providing a caller using a cellular telephone with an estimated wait time for calling a party engaged in a conversation with at least another party following a termination of the conversation, the system including: a wireless communications network for communicating with a plurality of mobile stations, wherein the network includes at least one computer having machine readable media and a computer program product stored thereon for implementing machine readable instructions, the instructions for: identifying at least one party to the conversation; using the identity of the at least one party, determining the estimated wait time for the caller by referencing a log to obtain historical call information and characterizing the conversation according to at least one of time of day, a location where the conversation originated, a location of at least one party, use of stationary equipment and use of a mobile station; and providing the estimated wait time to the caller by displaying the wait time to the caller, initiating a count down timer for progressively adjusting the wait time and initiating a call to the party at the end of the wait time; wherein the conversation includes one of a two-way call, a three-way call and a conference call.

### TECHNICAL EFFECTS

As a result of the summarized invention, technically we have achieved a solution which a computer program product stored on machine readable media and including machine readable instructions for providing a caller with an estimated wait time for successfully calling a party engaged in a conversation with at least another party following a termination of the conversation, is provided, the instructions for: identifying at least one party to the conversation; using the identity of the at least one party, determining the estimated wait time for the caller; and providing the estimated wait time to the caller.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

The method of estimating the wait time for a cell phone user and the method of initiating a subsequent call when the wait time elapses, as disclosed in this invention,

FIG. 1 illustrates one example of a wireless communication system in which the present invention may be implemented.

FIG. 2 illustrates exemplary aspects of relationships within the wireless communication system;

FIG. 3 provides a flowchart illustrating a process for identifying at least one of the parties to a telephone conversation and estimating a wait time; and

FIG. 4 illustrates examples of information included in historical logs.

The detailed description explains the preferred embodiments of the invention, together with advantages and features, by way of example with reference to the drawings.

### DETAILED DESCRIPTION OF THE INVENTION

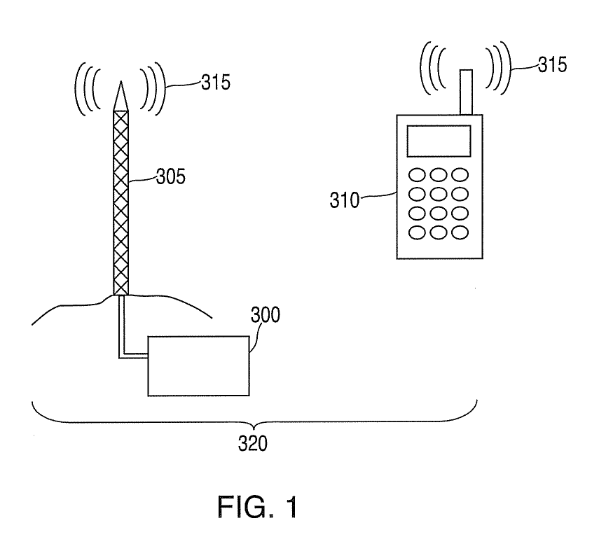

Referring to FIG. 1, there are shown aspects of a wireless communications network 320. The wireless communications network 320, or network 320, includes a variety of components for providing service to a plurality of mobile stations 310. In one example, the network 320 is managed by a system operator 300. The system operator 300 and the mobile station 310 exchange information by transmission and receipt of wireless signals 315. Typically, the wireless communications network 320 is a cellular network, however, other networks may be used equally well with the teachings herein. Another exemplary system includes a radio or “walkie-talkie” style network, while yet another system includes a satellite-based system. Therefore, although the mobile station 310 may be generally referred to herein as a “cell phone,” this is merely illustrative and non-limiting of the teachings herein.

Typically, network 320 includes a variety of resources, including, for example, an network infrastructure 305 having components such as power supplies, antennae, computers, computer networks, databases, maintenance providers, and other such resources as are known in the art for supporting operation of the network 320.

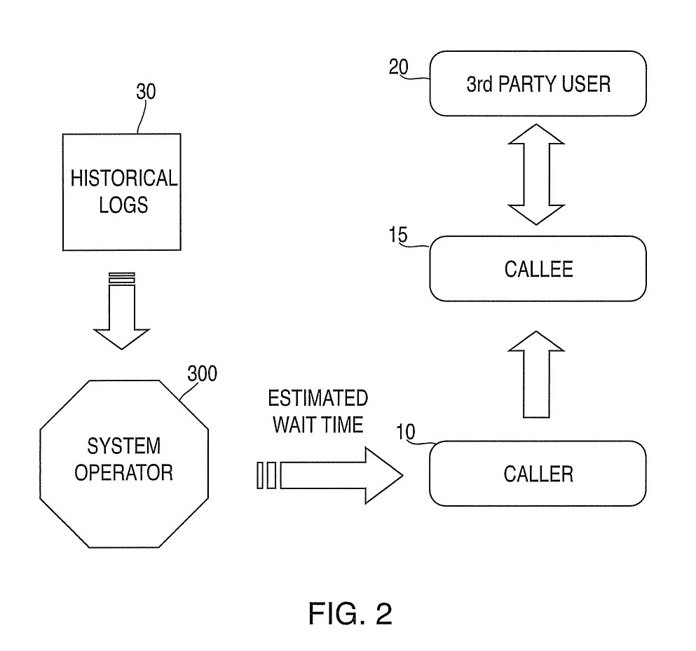

FIG. 2 depicts exemplary relationships between a person placing a call (i.e., a caller 10) and a person designated to receive a call (i.e., a callee 15). FIG. 2 shows that when the caller 10 tries to reach the callee 15, the callee 15 may be already engaged in a conversation with a third party user 20. One skilled in the art will understand that a “conversation” is not limited to verbal discourse, but may include data transmission and reception as well as other discourse.

In accordance with a typical embodiment, when the callee 15 is engaged in a conversation with the third party user 20, the system operator 300 estimates the amount of time the callee 15 will be unavailable and provides the estimated time to the caller 10. In typical embodiments, the estimated time is derived from knowledge of prior conversations. The knowledge is typically stored in historical logs 30 that provide information regarding various aspects of the prior calls.

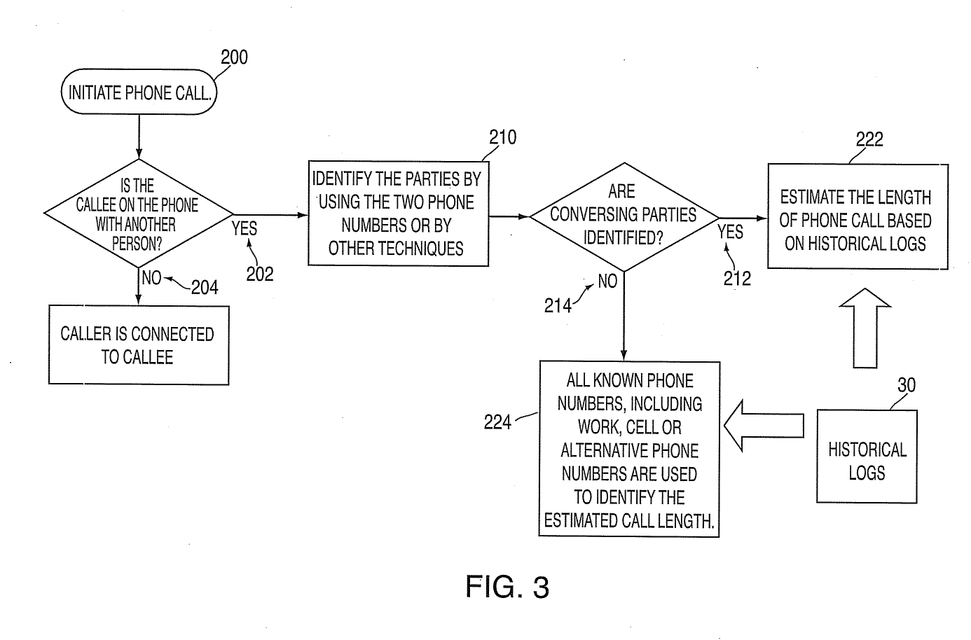

As an example, the system operator 300 refers to the historical logs 30 to determine an average length of time for conversations between the callee 15 and the third party user 20. Using the determination, the system operator 300 provides an estimated length of time to the caller 10. Further aspects are depicted in FIG. 3.

Referring now to FIG. 3, if the callee 15 is on the phone with the third party user 20 when the caller 10 initiates a call 200, the system operator 300 may identify the parties to the conversation by identifying the two phone numbers being currently used or by other techniques 210.

If the parties to the conversation are identified 212, an approximate time the callee 15 will be on the phone will be estimated 222 based on the historical logs 30. In some embodiments, if only one of the talking parties is identified 214, all known phone numbers, including work, cell, and alternative numbers in the historical logs 30 can be used to estimate the calling time 214.

The parties to the conversation may be identified by the current phone numbers being used or by other techniques 210 without relying on the phone numbers being used.

One skilled in the art will also recognize that although the conversations discussed make reference to two way calling, the teachings herein may be applied to other calling types. For example, three-way calling and conference calling may make use of the teachings disclosed herein.

Typically, the system operator 300 estimates the approximate wait time by talking advantage of the information available in the historical logs 30 once the parties to the conversation have been identified.

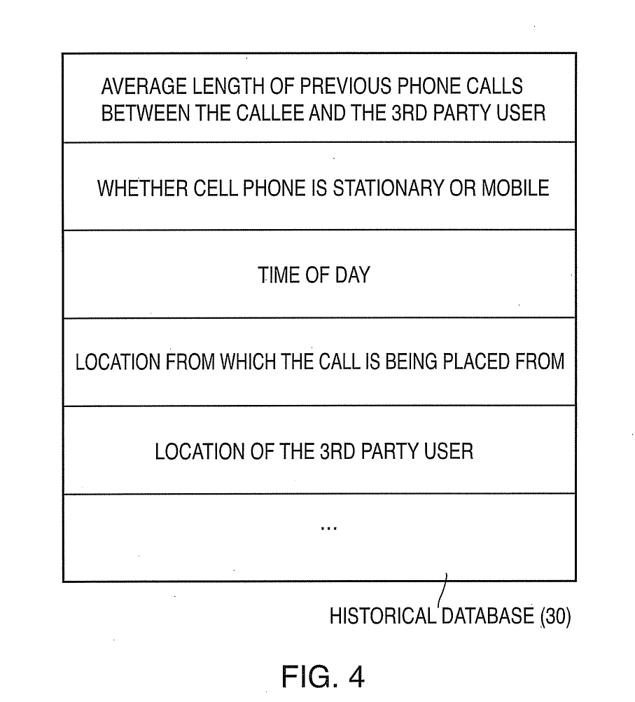

Referring to FIG. 4, exemplary historical logs 30 include, and are not limited to, information on the average length of previous phone calls between the callee 15 and the third party user 20, whether the present conversation with the third party user 20 is being completed using stationary equipment or another mobile station, time of day, the location of where the conversation originated, and the location of at least one of the callee 15 and the third party user 20.

Whether a conversation involves use of stationary equipment or another mobile station may be taken into consideration. For example, it may be recognized that calls tend to be shorter when one is traveling than when one is stationary. This may be used to weight an estimation for wait time appropriately. In short, a variety of statistical analyses may be used to characterize the conversation to determine an accurate estimation of wait time.

In one embodiment, when the average length of previous phone calls has been estimated based on information provided in the historical logs 30, the amount of time the callee 15 has already been on the phone would be deducted from the average length of phone calls between the callee 15 and the third party user 20. In some further embodiments, a count down timer is included to progressively adjust the estimated wait time.

In some embodiments, the system operator 300 provides the estimated wait time in a display register of the mobile station 310. In some additional embodiments, the system operator 300 initiates a call on behalf of the caller 10 when the estimated wait time has passed. The initiated call may further attract the caller 10 by ringing the mobile station of the caller 310.

The system operator 300 is not limited to operation of the wireless communications network 320. That is, the teachings herein may be applied to other systems such as those using traditional hard-wired equipment as well. More specifically, and as an example, the system operator 300 might operate hard-wired equipment from which the caller 10 attempts to originate the conversation with one of other hard-wired equipment and another mobile station 310.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing a caller with an estimated wait time for calling a party engaged in a conversation with at least another party following a termination of the conversation, the method comprising:
identifying at least one party to the conversation;
using the identity of the at least one party, determining the estimated wait time for the caller; and
providing the estimated wait time to the caller.

2. The method as in claim 1, wherein the determining comprises referencing a log to obtain historical call information.

3. The method as in claim 1, wherein the determining comprises characterizing the conversation according to at least one of time of day, a location where the conversation originated, a location of at least one party, use of stationary equipment and use of a mobile station.

4. The method as in claim 1, wherein the caller initiates the calling using a mobile station.

5. The method as in claim 4, wherein the mobile station comprises a cellular telephone.

6. The method as in claim 1, wherein the conversation comprises one of a two-way call, a three-way call and a conference call.

7. The method as in claim 1, wherein providing comprises displaying the wait time to the caller.

8. The method as in claim 1, wherein providing comprises initiating a count down timer for progressively adjusting the wait time.

9. The method as in claim 1, further comprising initiating a call to the party at the end of the wait time.

10. A computer program product stored on machine readable media and comprising machine readable instructions for providing a caller with an estimated wait time for successfully calling a party engaged in a conversation with at least another party following a termination of the conversation, the instructions for:
identifying at least one party to the conversation;
using the identity of the at least one party, determining the estimated wait time for the caller; and
providing the estimated wait time to the caller.

11. The computer program product as in claim 10, wherein the determining comprises referencing a log to obtain historical call information.

12. The computer program product as in claim 10, wherein the determining comprises characterizing the conversation according to at least one of time of day, a location where the conversation originated, a location of at least one party, use of stationary equipment and use of a mobile station.

13. The computer program product as in claim 10, wherein the caller initiates the calling using a mobile station.

14. The computer program product as in claim 13, wherein the mobile station comprises a cellular telephone.

15. The computer program product as in claim 10, wherein the conversation comprises one of a two-way call, a three-way call and a conference call.

16. The computer program product as in claim 10, wherein providing comprises displaying the wait time to the caller.

17. The computer program product as in claim 10, wherein providing comprises initiating a count down timer for progressively adjusting the wait time.

18. The computer program product as in claim 10, further comprising initiating a call to the party at the end of the wait time.

19. A system for providing a caller using a cellular telephone with an estimated wait time for calling a party engaged in a conversation with at least another party following a termination of the conversation, the system comprising:
a wireless communications network for communicating with a plurality of mobile stations, wherein the network comprises at least one computer having machine readable media and a computer program product stored thereon for implementing machine readable instructions, the instructions for:
identifying at least one party to the conversation;
using the identity of the at least one party, determining the estimated wait time for the caller by referencing a log to obtain historical call information and characterizing the conversation according to at least one of time of day, a location where the conversation originated, a location of at least one party, use of stationary equipment and use of a mobile station; and
providing the estimated wait time to the caller by displaying the wait time to the caller, initiating a count down timer for progressively adjusting the wait time and initiating a call to the party at the end of the wait time;
wherein the conversation comprises one of a two-way call, a three-way call and a conference call.
